(19) United States
(12) Patent Application Publication
(10) Pub. No.: US 2018/0127970 A1
(43) Pub. Date: May 10, 2018

(54) Hanger with Positioning Tab

(71) Applicant: Thomas G. Evans, Dublin, CA (US)

(72) Inventor: Thomas G. Evans, Dublin, CA (US)

(21) Appl. No.: 15/348,612

(22) Filed: Nov. 10, 2016

(51) Int. Cl. E04B 1/26

(52) U.S. Cl. CPC E04B 1/2612; F16M 13/025; E04B 1/2608

(57) ABSTRACT

A connection is provided that utilizes a hanger having a seat member, side members connected to the seat member and back members connected to the side members. The seat member is formed with a connection tab. The connection tab can extend from the back of the seat member past the back flanges, or the connection tab can be bent at an angle to the seat member. The bent connection tab can be aligned with the back members.

### BACKGROUND

The invention relates to a connector used in building construction, and in particular to a structural hanger for suspending a held framing member from a holding framing member, where the seat of the hanger is formed with a extending tab that can be bent in the field.

Structural hangers are well known in the art. British Patent 422,765 granted to Wilfred P. Durman in 1935 represents an early patent to a structural hanger made from sheet metal. The Durman patent teaches forming the seat and side members of the hanger with flanges bent at right angles to the seat and side members. These flanges connected to the side members are back members that connect to the holding framing member. The flange connected to the seat member is not connected to the holding framing member.

British Patent 435,226, granted to George Hedgecock in 1935 represents a similarly early patent to a structural hanger made from sheet metal. The Hedgecock patent also teaches forming the seat and side members of the hanger with flanges or lugs bent at right angles to the seat and side members. The flanges connected to the side members are back members that connect to the holding framing member. Like British Patent 422,765, Hedgecock is also formed with a flange connected to the seat member at a right angle, but the flange connected to the seat member in Hedgecock also connects the seat to the holding framing member.

British Patent 2 400 384, invented by Ian Harrison and published in 2005 represents a recent patent to a structural hanger made from sheet metal that has a flange or extending tab attached to the seat member that extends from the seat member in the same plane and attaches to the bottom face of the holding framing member. The extending tab is connected to the bottom face of the holding framing member and increases the load values for the hanger.

The present invention has a connection or extending tab connected to the seat of the hanger and represents an improvement over the prior art.

### SUMMARY OF THE INVENTION

The present invention provides a hanger having a seat member, side members connected to the seat member and back members connected to the side members. The seat member is formed with a connection tab. According to the present invention, the connection tab can extend from the back of the seat member past the back flanges, or the connection tab can be bent at an angle to the seat member. The bent connection tab can be aligned with the back members.

According to the present invention, the connection tab has a slotted opening at the interface between the seat member and the connection tab. The slotted opening at the interface makes it easy to bend the connection tab out of alignment with the seat member or into alignment with the seat member.

According to the present invention, the connection tab is formed with at least one fastener opening. The fastener opening allows for the optimal positioning of a fastener in the connection tab to connect the connection tab to the holding framing member.

The present invention also provides a connection between a holding framing member and a held framing member where the members are connected by a structural hanger having a seat member with a connection tab and the connection tab is disposed in substantially the same plane as the seat member and the connection tab interfaces with the bottom surface of the holding framing member.

The present invention also provides a connection between a holding framing member and a held framing member where the members are connected by a structural hanger having a seat member with a connection tab and the connection tab is disposed at an angle to the seat member and the connection tab interfaces with the attachment surface of the holding framing member.

### BRIEF DESCRIPTION OF THE DRAWINGS

FIG. 1 is a perspective view of the connection of the present invention.

FIG. 2 is side view of the connection of the present invention.

FIG. 3 is a front perspective view of the connector of the present invention.

FIG. 4 is a back perspective view of the connector of the present invention.

FIG. 5 is a perspective view of an alternate connection of the present invention.

FIG. 6 is side view of the alternate connection of the present invention of FIG. 5.

FIG. 7 is a front perspective view of the alternate connector of FIG. 5.

FIG. 8 is a back perspective view of the alternate connector of FIG. 5.

FIG. 9 is a top view of the connector of FIG. 3.

FIG. 10 is a bottom view of the connector of FIG. 3.

FIG. 11 is a front view of the connector of FIG. 3.

FIG. 12 is a back view of the connector of FIG. 3.

FIG. 13 is a side view of the connector of FIG. 3. The alternate side view is the same.

FIG. 14 is a top view of the connector of FIG. 7.

FIG. 15 is a bottom view of the connector of FIG. 7.

FIG. 16 is a front view of the connector of FIG. 7.

FIG. 17 is a back view of the connector of FIG. 7.

FIG. 18 is a side view of the connector of FIG. 7. The alternate side view is the same.

FIG. 19 is a top view of an alternate connector of the present invention.

FIG. 20 is a bottom view of the connector of FIG. 19.

FIG. 21 is a front view of the connector of FIG. 19.

FIG. 22 is a back view of the connector of FIG. 19.

FIG. 23 is a side view of the connector of FIG. 19. The alternate side view is similar.

FIG. 24 is a top view of an alternate connector of the present invention.

FIG. 25 is a bottom view of the connector of FIG. 24.

FIG. 26 is a front view of the connector of FIG. 24.

FIG. 27 is a back view of the connector of FIG. 24.

FIG. 28 is a side view of the connector of FIG. 24. The alternate side view is similar.

FIG. 29 is a perspective view of an alternate connection of the present invention using the connector of FIG. 19.

### DETAILED DESCRIPTION OF THE INVENTION

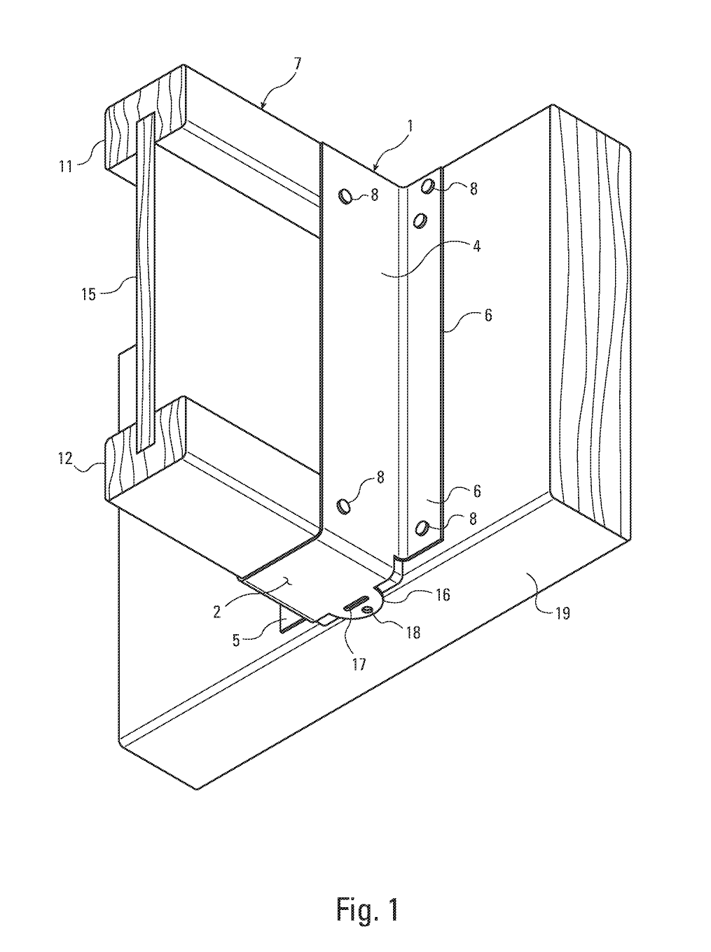

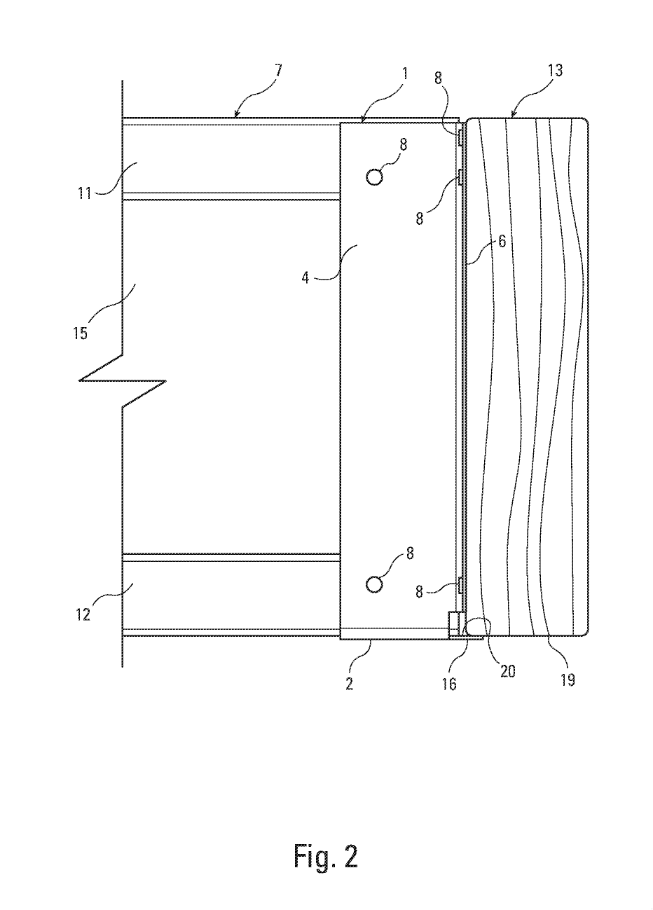

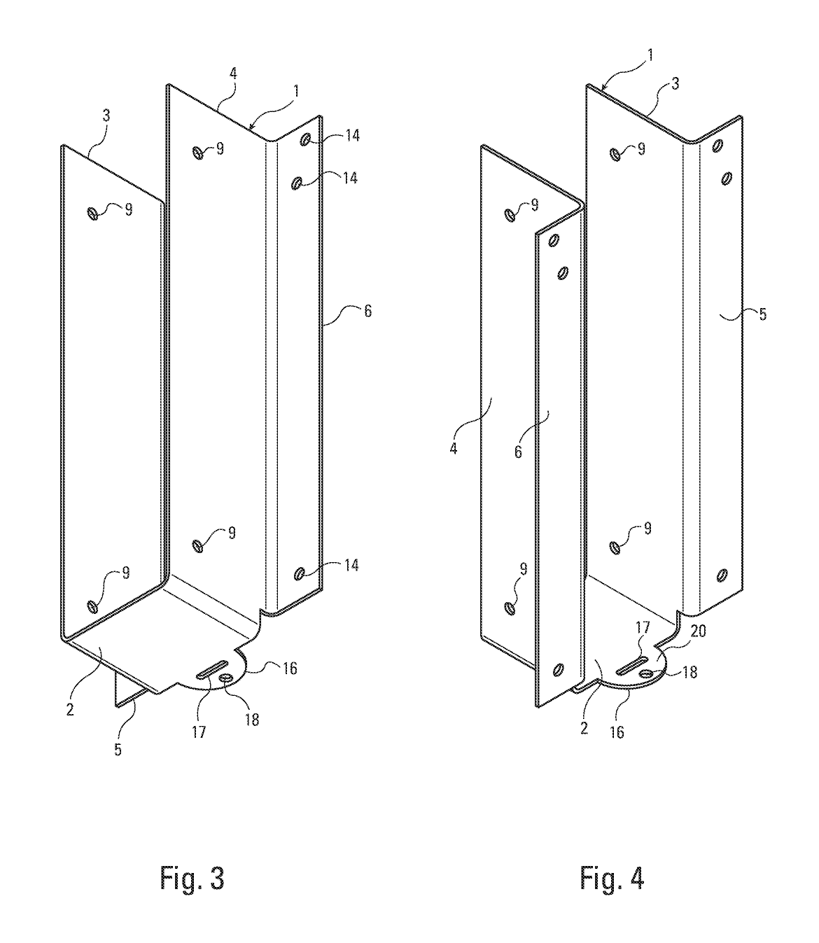

As shown in FIG. 1, the connector 1 has a seat member 2, upstanding left and right side flanges 3 and 4 connected on either side of the seat member 2, and left and right back flanges 5 and 6, connected to the left and right side members 5 and 6 respectively. The connector 1 is preferably formed from light gauge sheet metal, preferably steel.

As is also shown in FIG. 1, the connector 1 receives a joist or held framing member 7 between the side flanges 3 and 4. The joist 7 is connected to the side flanges 3 and 4 by means of fasteners 8 which are preferably nails or screws. Openings 9 are preferably formed in the side flanges 3 and 4 to receive the fasteners 8. The side flanges 3 and 4 preferably extend to the top 10 of the joist 8, so as to stabilize the joist 7. Furthermore, when the joist is an I-Joist, as shown in FIG. 1, having the side flanges 3 and 4 extend from the seat member 2 to or near the top 10 of the I-joist it allows fasteners to be placed in the top chord 11 of the I-joist 7. As is also shown in FIG. 1, the side flanges 3 and 4 also have fastener openings 9 that allow fasteners to be placed in the bottom chord 12 of the I-joist. As is also shown in FIG. 1, the joist 7 is preferably supported by the seat member 2.

As is also shown in FIG. 1, the connector 1 is attached to a header or holding framing member 13. The connector 1 is attached to the header 13 by means of the back flanges 5 and 6 and by means of fasteners 8 which are preferably nails or screws. Openings 14 are preferably formed in the back flanges 5 and 6 to receive the fasteners 8. The connector 1, as shown, is preferably a face mount hanger 1 with no top flanges for engaging the top surface of the header 13.

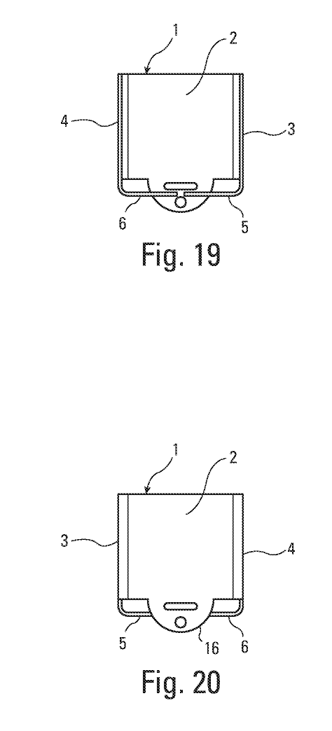

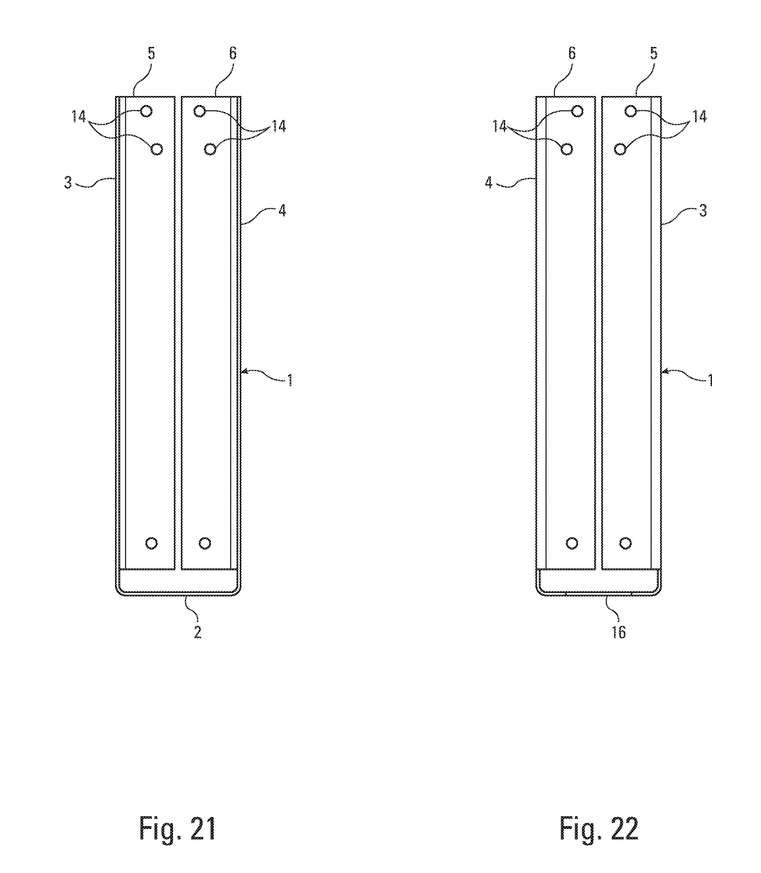

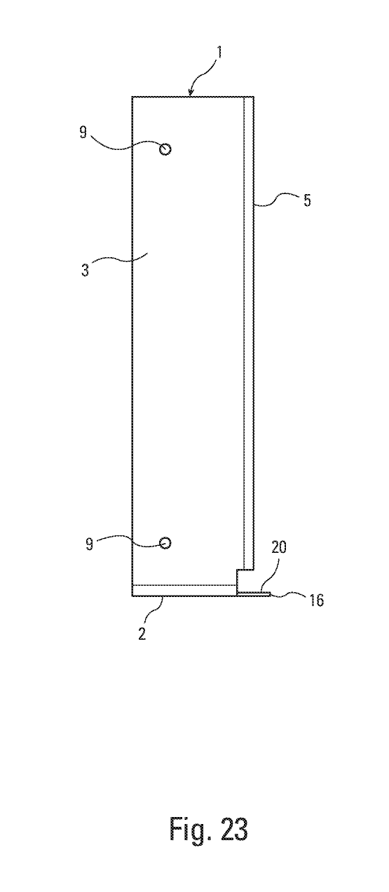

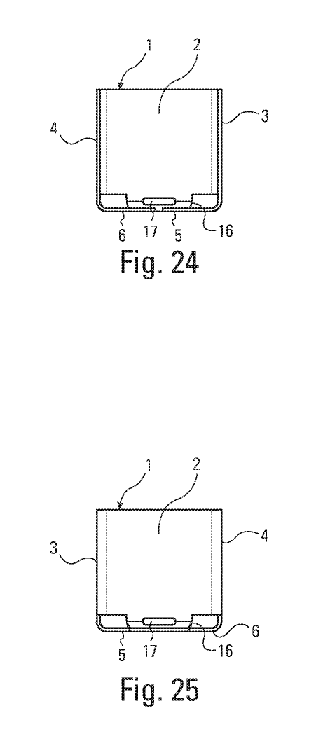

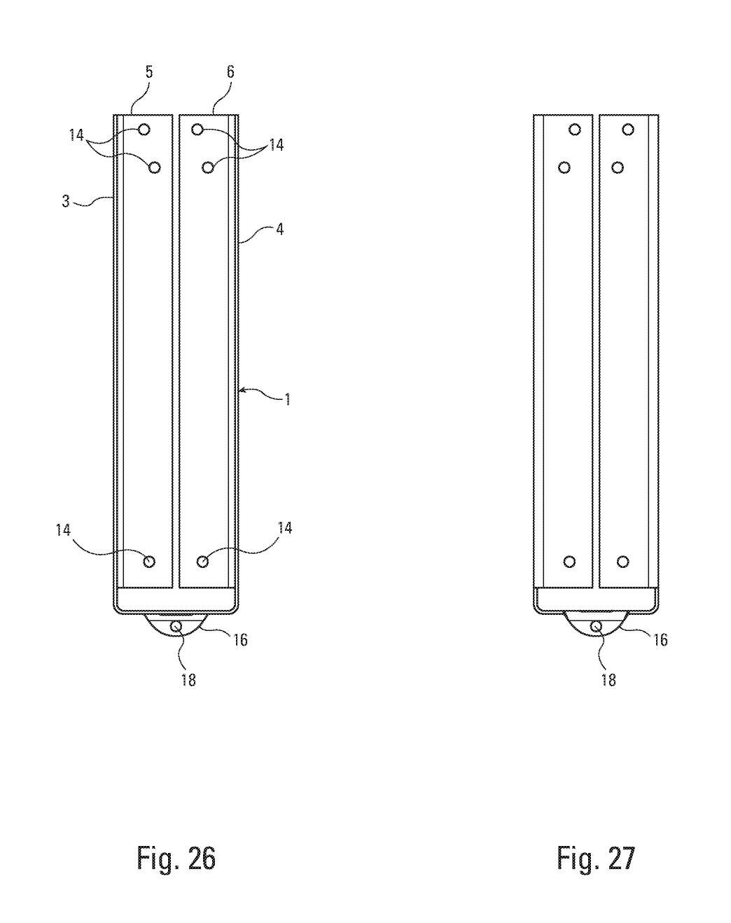

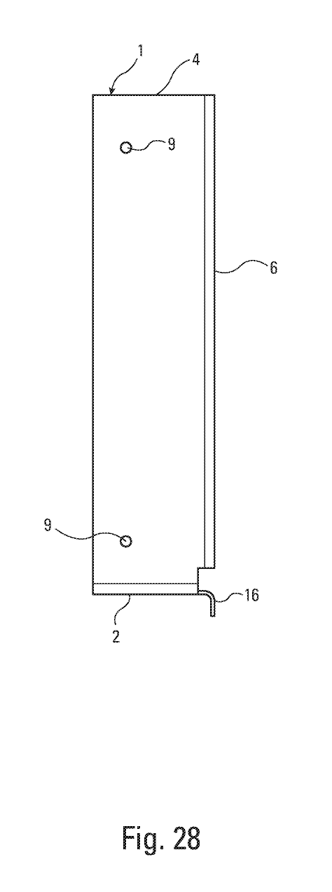

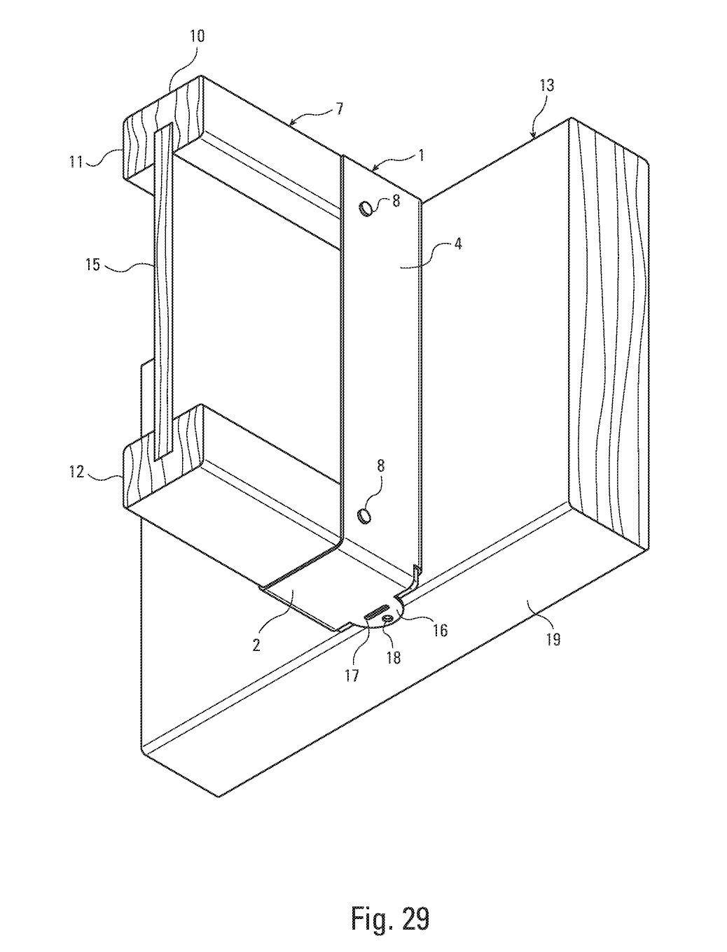

As shown in FIGS. 19-29, the back flanges 5 and 6 preferably are bent in towards each other so that they are disposed behind the seat member 2. The back flanges 5 and 6 preferably extend as high as the side flanges 3 and 4.

As shown in FIG. 1, a web member 15 connects the top chord 11 and the bottom chord 12 of the I-Joist 7.

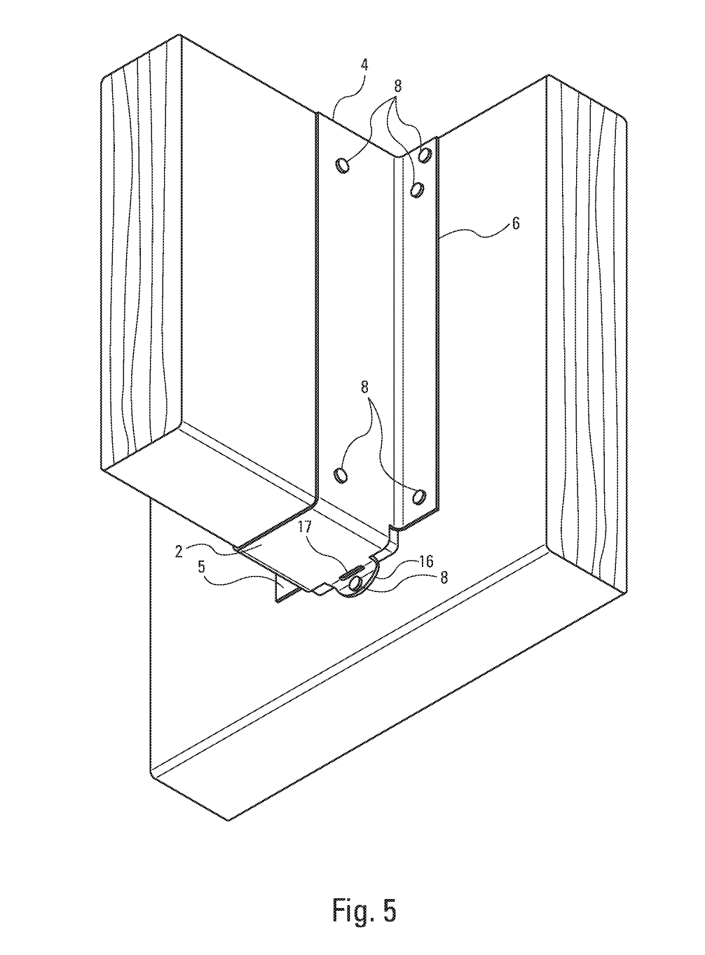

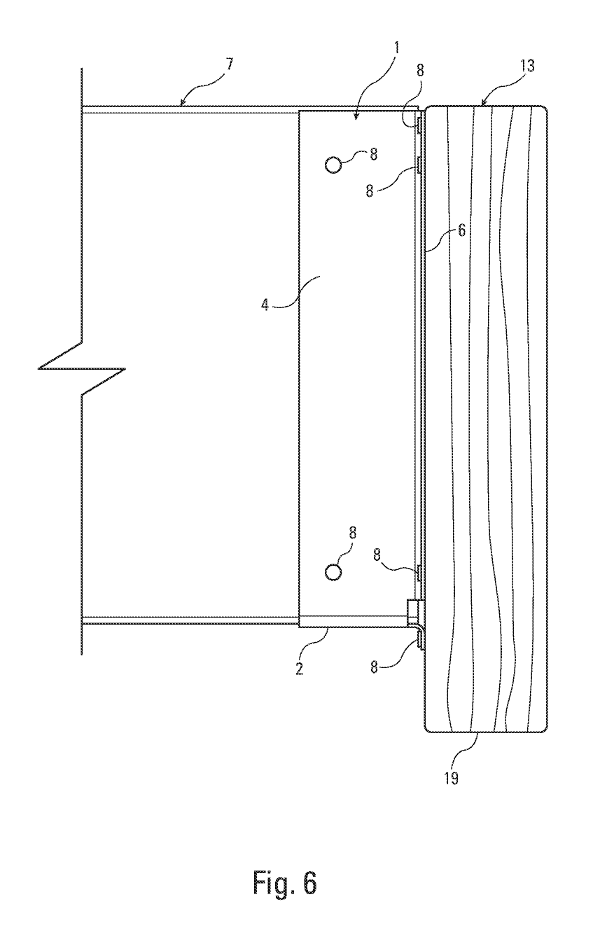

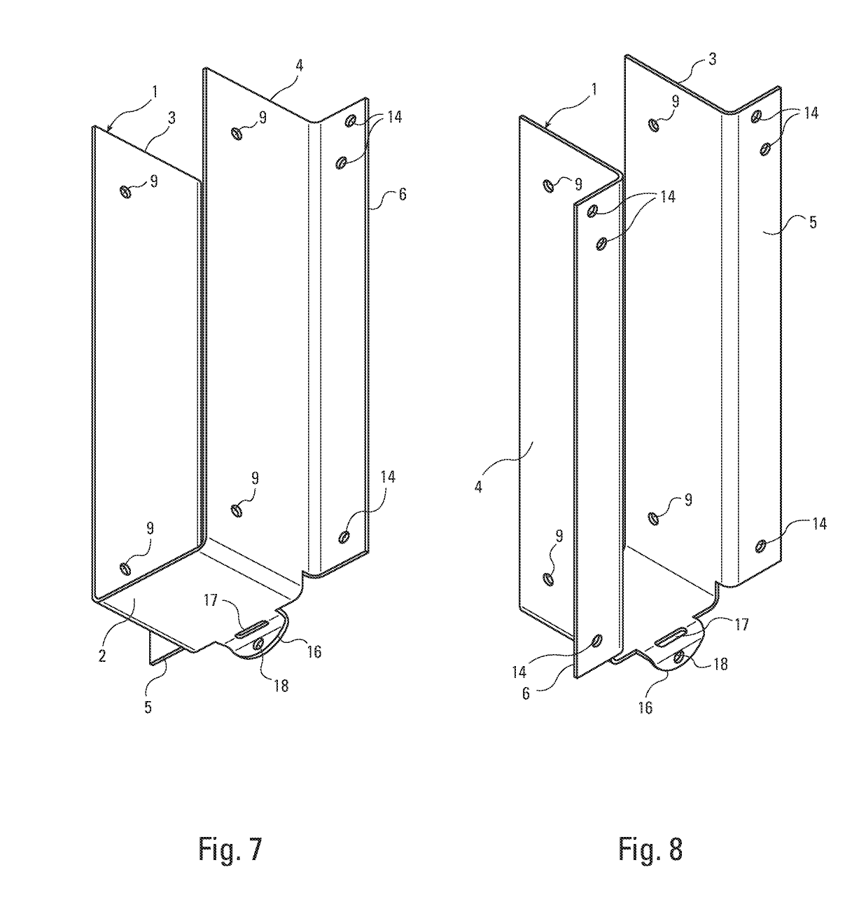

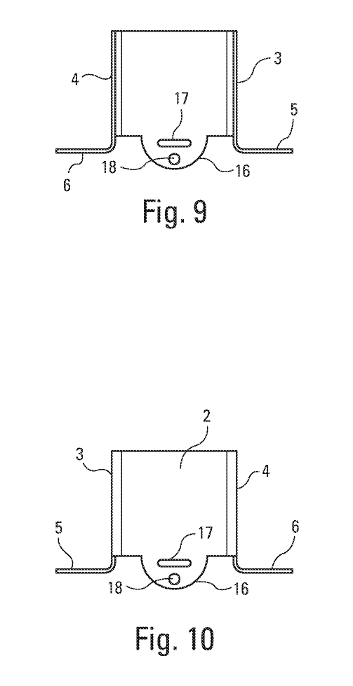

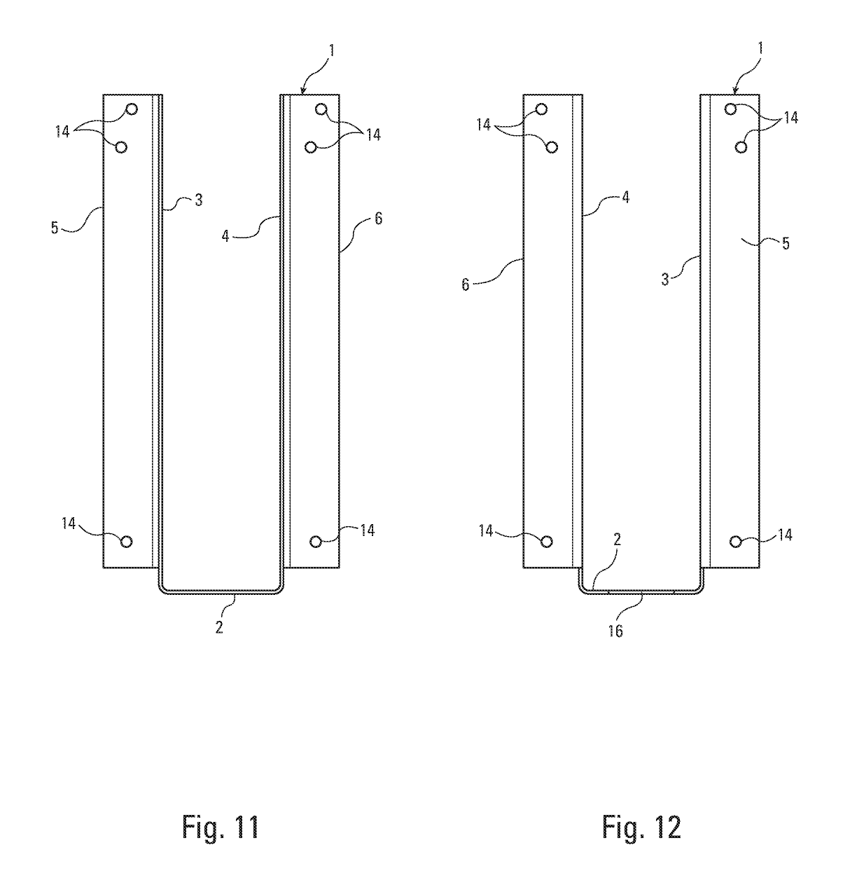

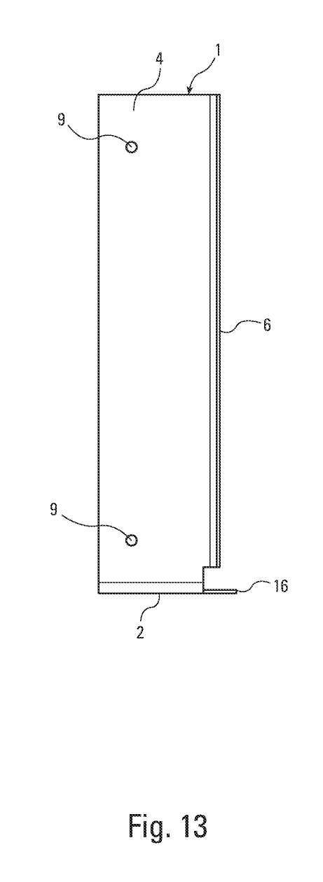

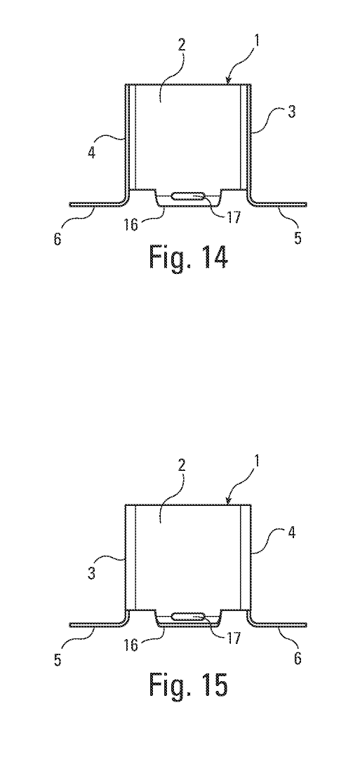

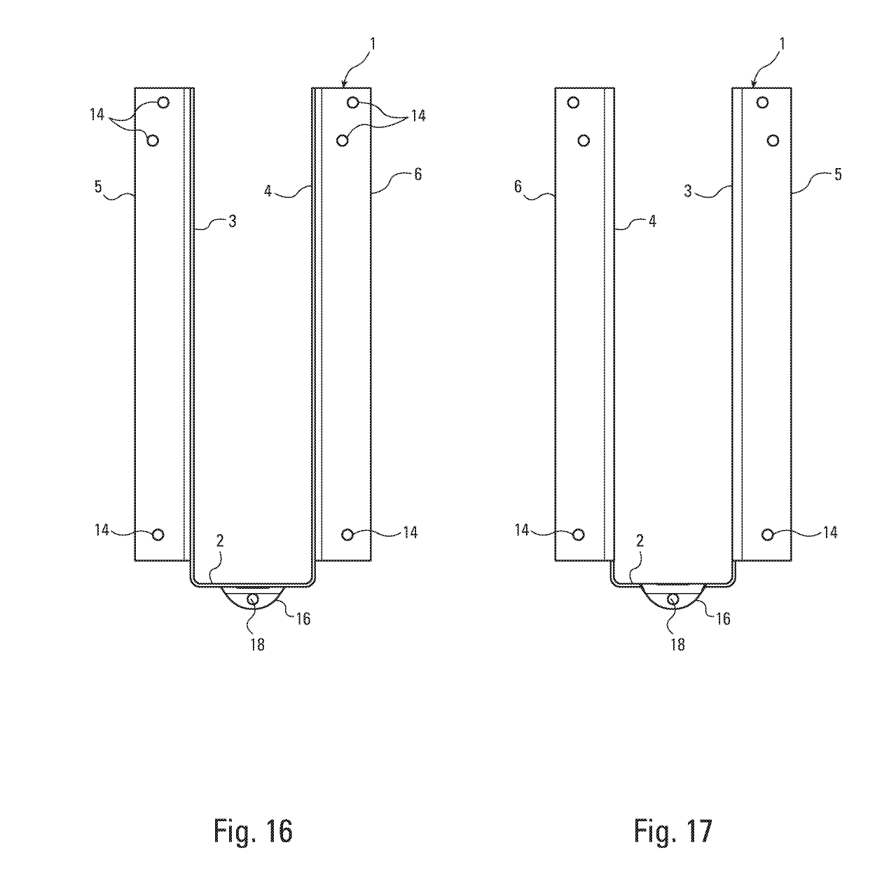

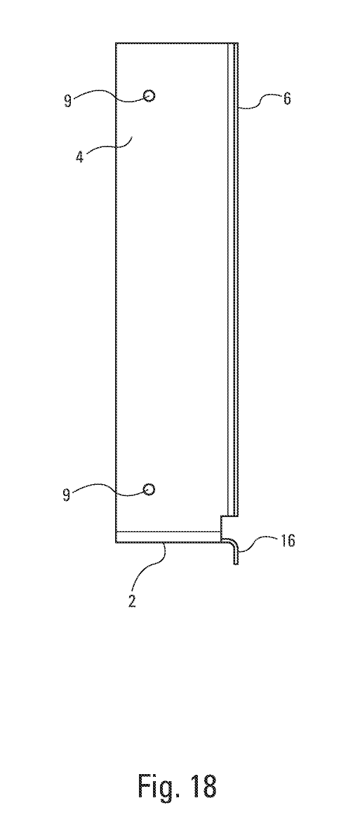

As shown in FIG. 1, the seat member 2 is preferably formed with a connection tab 16 extending from the back of the seat member 2 past the back flanges 5 and 6. The connection tab 16 preferably has a slotted opening 17 at the interface between the seat member 2 and the connection tab 16. The connection tab 16 also preferably has a fastener opening 18. The slotted opening is used to make it easy to bend the connection tab 16 in the field, if the hanger or connector 1 is to be attached as shown in FIG. 5 where the header 13 extends below the seat member 2. As shown in FIG. 5, the fastener opening 18 can receive a fastener 8 to further connect the hanger 1 to the header 13. The connection tab 16 can be used to help index the hanger 1 into the proper position, in certain instances, as shown in FIG. 1. The connection tab 16 is used when the seat of the hanger 2 should be substantially aligned with the bottom face 19 of the header 13. The upper face 20 of the connection tab interfaces with the bottom face 19 of the header 13.

I claim:

1. A connection utilizing a joist hanger to hang a held framing member from a holding framing member in cooperation with a first plurality of fasteners, the connection comprising:
a. the first plurality of fasteners;
b. the holding framing member;
c. the held framing member; and
d the hanger supporting the held framing member and connected to the holding framing member by one or more of the first plurality of fasteners, the hanger including:
i. a left back plate member;
ii. a right back plate member;
iii. a left side member connected to the left back plate member;
iv. a right side member connected to the right back plate member; and
v. a planar seat member connecting the left side member to the right side member; wherein:
e. the planar seat member is formed with a connection tab that extends either rearwardly in the plane of the seat member or can be bent to be disposed at an angle to the plane of the seat member.

2. The connection of claim 1, wherein:
the connection tab extends rearwardly from the seat member past the left and right back flanges.

3. The connection of claim 1, wherein:
the connection tab has a slotted opening at the interface between the planar seat member and the connection tab.

4. The connection of claim 1, wherein:
a. the connection tab has a fastener opening, and
b. the fastener opening receives a fastener of the first plurality of fasteners to connect the hanger to the holding support member.

5. The connection of claim 1, wherein:
the planar seat member is aligned with a bottom face of the holding framing member.

6. The connection of claim 5, wherein:
the connection tab has an upper face, and the upper face of the connection tab interfaces with the bottom face of the holding framing member.

7. The connection of claim 1, wherein:
the one or more of the first plurality of fasteners connects the held framing member to the left and right side flanges.

8. The connection of claim 7, wherein:
openings are formed in the left and right side flanges to receive the one or more fasteners of the first plurality of fasteners.

9. The connection of claim 1, wherein:
the left and right side flanges extend to a top of the held framing member.

10. The connection of claim 1, wherein:
a. the held framing member has a top chord and a bottom chord connected by a web; and
b. one or more fasteners of the first plurality of fasteners are driven through the left side flange and the right side flange into the top chord of the held framing member.

11. The connection of claim 1, wherein:
a. the held framing member has a top chord and a bottom chord connected by a web; and
b. one or more fasteners of the first plurality of fasteners are driven through the left side flange and the right side flange into the bottom chord of the held framing member.

12. The connection of claim 11, wherein:
one or more fasteners of the first plurality of fasteners are driven through the left side flange and the right side flange into the top chord of the held framing member.

13. The connection of claim 12, wherein:
the connection tab extends rearwardly from the seat member past the left and right back flanges.

14. The connection of claim 13, wherein:
the connection tab has a slotted opening at the interface between the planar seat member and the connection tab.

15. The connection of claim 14, wherein:
a. the connection tab has a fastener opening, and
b. the fastener opening receives a fastener of the first plurality of fasteners to connect the hanger to the holding support member.

16. The connection of claim 15, wherein:
the planar seat member is aligned with a bottom face of the holding framing member.

17. The connection of claim 16, wherein:
the connection tab has an upper face, and the upper face of the connection tab interfaces with the bottom face of the holding framing member.

18. The connection of claim 17, wherein:
openings are formed in the left and right side flanges to receive the one or more fasteners of the first plurality of fasteners.

19. The connection of claim 18, wherein:
the left and right side flanges extend to a top of the held framing member.
